(19) United States
(12) Patent Application Publication
(10) Pub. No.: US 2014/0291393 A1
(43) Pub. Date: Oct. 2, 2014

(54) Method Performed by a Card Reader and a Card Reader

(71) Applicants: Carl Hyslop, Stockholm (SE); Frans Henrik Kockum, Stockholm (SE)

(72) Inventors: Carl Hyslop, Stockholm (SE); Frans Henrik Kockum, Stockholm (SE)

(21) Appl. No.: 14/222,545

(22) Filed: Mar. 21, 2014

(30) Foreign Application Priority Data
Mar. 22, 2013 (SE) 1350365-1

(51) Int. Cl. G06Q 20/38

(52) U.S. Cl. CPC G06Q 20/3827
USPC 235/380

(57) ABSTRACT

A card reader and a method performed by a card reader, comprising receiving in the card reader a card comprising data stored on the card, indicating the identity of a person, obtaining data from the card, detecting any valid primary account number in the data, upon detecting a valid primary account number in the data, truncating the data by redacting parts of the detected valid primary account number to remove sensitive data while maintaining the issuer identification number of the primary account number and the last four digits of the valid primary account number.

### CROSS-REFERENCE TO RELATED APPLICATIONS

This application claims priority to SE 1350365-1, filed on Mar. 22, 2013.

### BACKGROUND

The present invention relates generally to a method performed by a card reader, and to a card reader.

Various types of cards carry data which may be used to indicate the identity of a person carrying the card. These cards include but are not limited to payment cards, co-branded payment/loyalty cards and loyalty cards.

Data which may be used to indicate the identity of a person carrying the card includes but is not limited to the name of the card holder, payment account data and loyalty club information used by various companies such as retailers and airlines.

To enhance security while storing and transferring sensitive payment account data, such as data carried by some of the cards mentioned, certain regulations and requirements have been agreed. Unauthorised access and processing of such sensitive data is thereby rendered more difficult, increasing the safety for individuals using such cards.

### SUMMARY

It has therefore been identified as a problem to increase the data safety for the card holder while enabling simple and convenient identification in various situations, and to enable the extraction and transmission of identification data from a card carrying various pieces of information, in order to indicate the identity of a person carrying the card (the card holder) while limiting transmission of sensitive account data carried by the card.

An object of the present invention is thus to meet this problem and to enable the extraction and transmission of identification data from a card to indicate the identity of a person carrying the card while limiting transmission of sensitive account data which may be carried by the card.

Thus the invention relates to a method performed by a card reader, comprising receiving in the card reader a card comprising data stored on the card, indicating the identity of a person, and obtaining data from the card. The method further comprises detecting any valid primary account number (PAN) in the data. Upon detecting a valid primary account number in the data, the data is truncated by redacting parts of the detected valid primary account number so as to remove sensitive data while maintaining the issuer identification number (IIN) of the primary account number and the last four digits of the valid primary account number.

Thus the method automatically detects and truncates any valid primary account number in the data obtained by the card. Thereby extraction and transmission of identification data from the card to indicate the identity of a person carrying the card (the card holder) is enabled while limiting transmission of sensitive account data which may be carried by the card. By truncating any detected valid primary account number while maintaining the issuer identification number of the primary account number and the last four digits of the valid primary account number the data may be transmitted while maintaining a certain level of data security for the card holder.

The data may be transmitted to a system after processing by the method, wherein the data may be used to indicate the identity of the person.

The data may thus comprise loyalty data, such as frequent flyer number data, which is unaffected by any truncation of the data. This allows the use of cards including, but not limited to payment cards, co-branded payment/loyalty cards and loyalty cards, in order to provide simple and convenient identification in situations such as during airport check in, security checkpoint validation, or during boarding/deboarding.

The issuer identification number of the primary account number may be defined as the first six to eight digits of the primary account number, typically the first six digits of the primary account number.

The card may be a magnetic stripe card. The magnetic stripe may comprise a plurality of tracks, e.g. a first track, a second track and a third track, and wherein data is obtained from respective track. Thus the data may e.g. be obtained as first track data, second track data and third track data.

The card may comprise an integrated circuit, i.e being an integrated circuit card (smart card), and wherein first track data, second track data and third track data are constructed from the data obtained from the card. The card may be a hybrid card comprising two or more different means of carrying data, including but not limited to a magnetic stripe, an integrated circuit, a radio-frequency identification (RFID) tag or near field communication (NFC) circuit technology for proximity reading. Two or more means of obtaining data from the card may be used in order to obtain a level of redundancy.

It should be noted that according to one aspect of the invention the term card should be interpreted broadly to comprise any type of data carrier from which data may be retrieved magnetically, inductively, electrically, by wireless communication such as by means of radio-frequency identification (RFID) or near field communication (NFC) technology, etc.

Each of the first track data, the second track data and the third track data may be truncated individually upon detection of a valid primary account number in the respective track data. Thus the detection may be individualised for each track.

The detection of any valid primary account number in the data may comprise validating a detected primary account number by detecting and/or recognizing characters in the track data before and or after a detected primary account number. Thus valid primary account numbers may be quickly and efficiently identified.

The detection of a valid primary account number may also comprise searching for a valid primary account number in the data whereby the flexibility of the method may be increased.

Any detected primary account number may be validated to represent a valid identifier of a payment account, i.e. a valid primary account number. Thus only valid account identifiers may be affected by the truncation.

The detection of any valid primary account number in the data from the first track may comprise detecting an initial character ‘B’ initiating the track, detecting a primary account number following the initial character and detecting a following character ‘̂’ following the primary account number, in the data from the first track.

The detection of any valid primary account number in the data from the second track may comprise detecting a primary account number, detecting a following character ‘=’ following the primary account number, detecting a sequence following the following character comprising any two digits, followed by a digit ‘0’ or ‘1’, followed by any digit, followed by a digit ‘1’, ‘2’, ‘5’, ‘6’, ‘7’ or ‘9’, followed by a digit ‘0’, ‘2’, or ‘4’, followed by a digit ‘0’, ‘1’, ‘2’, ‘3’, ‘4’, ‘5’, ‘6’ or ‘7’, in the data from the second track.

The method may further comprise detecting any card expiration date in the data comprising or following the detected valid primary account number and truncating the data by redacting parts of the data, preferably parts or all data following the card expiration date. Thus data security may be further enhanced by removing potentially sensitive data.

The detection of any valid primary account number in the data from the third track may comprise detecting two initial digits initiating the track, followed by a primary account number, in the data from the third track.

The detection of any valid primary account number in the data may comprise detecting a primary account number in the data and validating the primary account number using the Luhn algorithm. The Luhn algorithm is a checksum formula used to validate credit card numbers. It is specified in ISO/IEC 7812-1 and is also described in U.S. Pat. No. 2,950,048. The Luhn algorithm comprises:

a. Doubling the value of alternate digits of the primary account number beginning with the second digit from the right (the first right hand digit is the check digit).

b. Adding the individual digits comprising the products obtained in (a) to each of the unaffected digits in the original number.

c. The added total obtained in (c) must be a number ending in zero (30, 40, 50, etc.) for the account number to be validated.

The detection of any primary account number in the data may comprise finding a contiguous sequence of 13 to 20 digits, wherein the first digit of the sequence is 3, 4, 5 or 6. Thus potentially valid primary account numbers may be efficiently detected.

The detection of a primary account number may also comprise searching for a primary account number in the data whereby the flexibility of the method may be increased.

The parts of the detected primary account number may be redacted by replacing some or all digits in the parts of the detected valid primary account number by other characters, preferably wildcard characters. Thus the amount of sensitive data in the processed data is limited while still indicating the primary account number type of data for identification purposes. The parts of the detected primary account number may alternatively be redacted by replacing some or all digits in the parts of the detected valid primary account number by random characters, or by masking, altering, removing, scrambling, encoding or encrypting the parts of the detected valid primary account number.

The method may alternatively comprise detecting any primary account number in the data, and, upon detecting a primary account number in the data, truncating the data by redacting first parts of the detected primary account number while maintaining second parts of the primary account number. Thus the method may be used to redact any contiguous string of digits in the data resembling a primary account number, irrespective of it representing a valid primary account number or not.

The invention further relates to a method of identifying a card holder at a mass-transit terminal, including but not limited to airports, train terminals, bus terminals, at hotels, amusement parks, libraries and the like, or in a point-of-service system providing identification locally or over a network, comprising providing a card reader performing the method disclosed herein and using the data to indicate the identity of the person holding the card.

The invention further relates to a card reader, comprising input means configured to read data stored in a card, a processing unit adapted to receive the data, and detect any valid primary account number in the data, wherein the processing unit is adapted to, upon detecting a valid primary account number in the data, truncating the data by redacting parts of the detected valid primary account number while maintaining the issuer identification number of the valid primary account number and the last four digits of the valid primary account number. Thus the advantages of the method disclosed may be achieved by the card reader.

The card reader may further comprise a buffer memory for temporary storage of at least parts of the data received from the input means and a memory for storing truncated data received from the processing unit.

The card reader may be a magnetic card reader for reading magnetic stripe cards. The card reader may alternatively or in addition be an integrated circuit card (smart card) reader for reading data from integrated circuit cards.

The processing unit may be adapted to receive first track data, second track data and third track data from the card. The processing unit may further be configured to perform the method according to what is disclosed herein.

The card reader may comprise a computer program, i.e. computer readable code means, which when run in the card reader causes the card reader to perform the method as disclosed herein.

The invention further relates to a computer program comprising computer readable code means, which when run in a card reader causes the card reader to perform the method as disclosed herein.

The invention further relates to a computer program product comprising such a computer program.

### BRIEF DESCRIPTION OF DRAWINGS

The invention is now described, by way of example, with reference to the accompanying drawings, in which:

FIG. 1 shows a schematic chart of a method performed by a card reader.

FIG. 2 shows a schematic chart of another method performed by a card reader.

FIG. 3 shows a schematic chart of a part of a method performed by a card reader.

FIG. 4 shows a schematic chart of another part of a method performed by a card reader.

FIG. 5 shows an example of a card reader according to an embodiment of the invention.

FIG. 6 shows a block chart of an example of an arrangement in a card reader according to an embodiment of the invention.

### DETAILED DESCRIPTION OF PREFERRED EMBODIMENTS

In the following, a detailed description of various embodiments of methods and devices is provided.

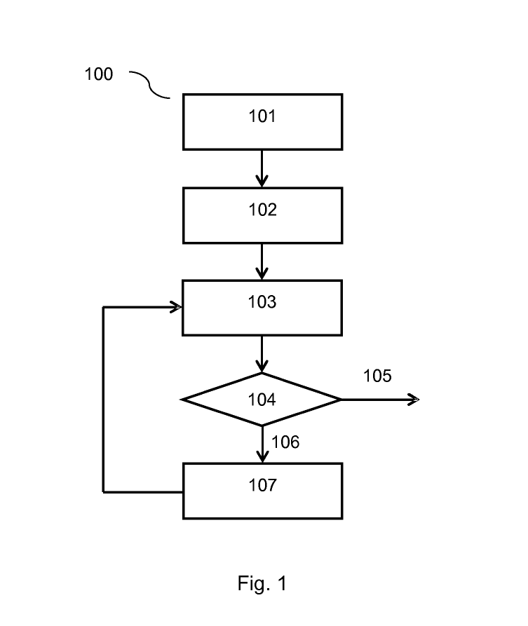

With reference to FIG. 1 an example of a method 100 performed by a card reader is disclosed. In the card reader a card is received 101 comprising data stored on the card. The card may be e.g. a magnetic stripe card or an integrated circuit card (i.e. a smart card) carrying data indicating the identity of a person holding the card (i.e. a card holder). The data may comprise various pieces of information that may be used to indicate the identity of the card holder, including but not limited to name information, information on the card issuer, account numbers, expiration date, loyalty club information etc. Each piece of information in the data, the combination of several pieces of information in the data or the combination of any pieces of information in the data with information from an external or internal database, such as booking, ticket, boarding card, loyalty club membership databases and the like, may provide the information needed to identify the card holder.

Upon receipt of the card in the card reader data is obtained 102 from the card. If the card is a magnetic stripe card data may be obtained by reading data from the magnetic stripe by an input means of the card reader comprising a magnetic reading head. If the card is a smart card, data may be obtained by reading data carried by the card from the integrated circuit by conventional input means for smart cards. Any other means to obtaining data from the card, e.g. near field communication (NFC) for NFC data carriers and/or RFID for RFID data carriers may be used in the method.

In the data obtained from the card the method searches for and/or detects 103 any valid primary account number (PAN) in the data. Valid primary account numbers may be detected by various steps as disclosed herein and described in detail further on.

Upon detection 104, 106 of a valid primary account number in the data the data is truncated 107 by redacting parts of the detected valid primary account number to remove sensitive data while maintaining the issuer identification number of the primary account number and the last four digits of the valid primary account number. The issuer identification number may be defined as the first six digits of the primary account number.

The method may thereafter be repeated by searching and detecting 103 any valid primary account number in the remaining data, or the data may be transmitted.

If in the step of detecting 103 any (further) valid primary account numbers in the data no (further) valid primary account numbers are detected 104, 105, the data may be transmitted from the card reader to be used to indicating the identity of the card holder. Typically the data is then received by a computerized system (not shown) for further processing. The method may be used at mass-transit terminals, including but not limited to airports, train terminals, bus terminals, at hotels, amusement parks, libraries and the like, or in point-of-service systems providing identification locally or over a network.

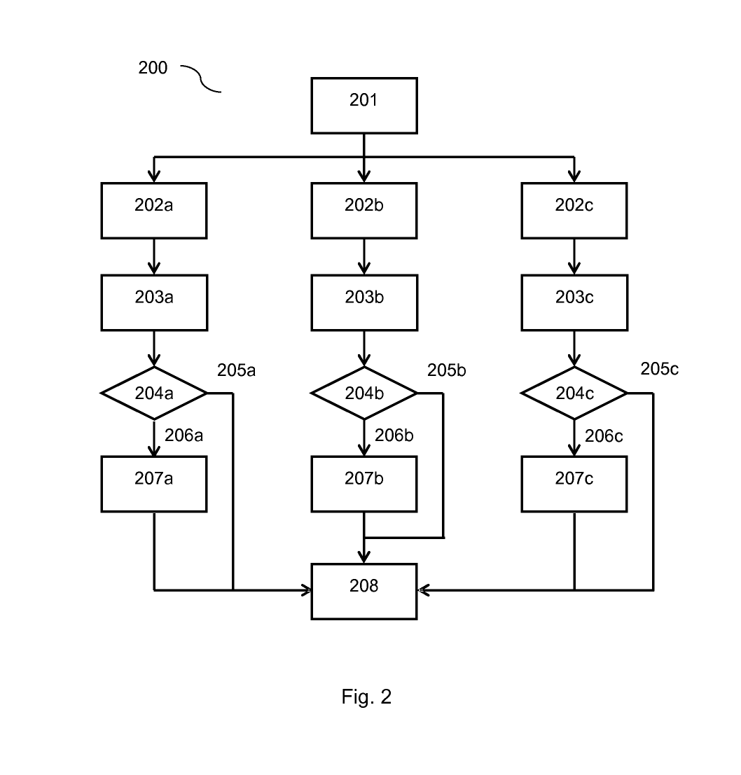

With reference to FIG. 2, another example of a method 200 performed by a card reader is disclosed. In the card reader a card is received 201 comprising data stored on the card. The method 200 is similar to what is disclosed above, further including that the data on the card is comprised on a plurality of tracks, in this case shown a first track, a second track and a third track. The card may be e.g. a magnetic stripe card comprising three tracks of data or a smart card carrying data which may be obtained and/or emulated in a form mimicking three magnetic stripe data tracks.

Upon receipt of the card in the card reader first track data is obtained 202a from the first track, second track data is obtained 202b from the second track and third track data is obtained 202c from the third track. Each of the tracks is thereafter processed individually.

In the first track data the method looks for and detects 203a any valid primary account number in the data. The detection of a valid primary account number comprises detecting a number in the form of a primary account number, and validating that it is a valid primary account number. These steps of the method are further elucidated in a general form below, with reference to FIG. 4. To detect a primary account number the method identifies a contiguous sequence of 13 to 20 digits, wherein the first digit of the sequence is 3, 4, 5 or 6. In the first track data the detection of a valid primary account number comprises detecting an initial character ‘B’ initiating the track, detecting a primary account number following the initial character and detecting a following character ‘̂’ following the primary account number, in the data from the first track.

If a valid primary account number is detected 204a, 206a in the first track data this primary account number is truncated 207a by redacting parts of the detected valid primary account number to remove sensitive data. In this example this is done by replacing each character of an intermediate portion of the primary account number by wildcard characters, e.g. ‘X’, while maintaining the issuer identification number of the primary account number and the last four digits of the valid primary account number. The issuer identification number may be defined as the first six digits of the primary account number. The first track data may thereafter be transmitted to a final step 208 of the method.

If in the step of detecting 203a any valid primary account numbers in the first track data no valid primary account numbers are detected 204a, 205a, the first track data may be transmitted to a final step 208 of the method.

In the second track data the method looks for and detects 203b any valid primary account number in the data. In the second track data the detection of a valid primary account number comprises detecting a primary account number, detecting a following character ‘=’ following the primary account number, detecting a sequence following the following character comprising any two digits, followed by a digit ‘0’ or ‘1’, followed by any digit, followed by a digit ‘1’, ‘2’, ‘5’, ‘6’, ‘7’ or ‘9’, followed by a digit ‘0’, ‘2’, or ‘4’, followed by a digit ‘0’, ‘1’, ‘2’, ‘3’, ‘4’, ‘5’, ‘6’ or ‘7’, in the data from the second track.

If a valid primary account number is detected 204b, 206b in the second track data this primary account number is truncated 207b by redacting parts of the detected valid primary account number to remove sensitive data. In this example this is done by replacing each character of an intermediate portion of the primary account number by wildcard characters, e.g. ‘X’, while maintaining the issuer identification number of the primary account number and the last four digits of the valid primary account number. The issuer identification number may be defined as the first six digits of the primary account number. The second track data may thereafter be transmitted to a final step 208 of the method.

If in the step of detecting 203b any valid primary account numbers in the second track data no valid primary account numbers are detected 204b, 206b, the first track data may be transmitted to a final step 208 of the method.

In the third track data the method looks for and detects 203c any valid primary account number in the data. In the third track data the detection of a valid primary account number comprises detecting two initial digits of any kind initiating the track, followed by a primary account number.

If a valid primary account number is detected 204c, 206c in the third track data this primary account number is truncated 207c by redacting parts of the detected valid primary account number to remove sensitive data. In this example this is done by replacing each character of an intermediate portion of the primary account number by wildcard characters, e.g. ‘X’, while maintaining the issuer identification number of the primary account number and the last four digits of the valid primary account number. The issuer identification number may be limited to the first six digits of the primary account number. The third track data may thereafter be transmitted to a final step 208 of the method.

If in the step of detecting 203c any valid primary account numbers in the third track data no valid primary account numbers are detected 204c, 206c, the first track data may be transmitted to a final step 208 of the method.

The data received in 208 from the first track processing, the second track processing and the third track processing may be merged and transmitted from the card reader to be used to indicating the identity of the card holder.

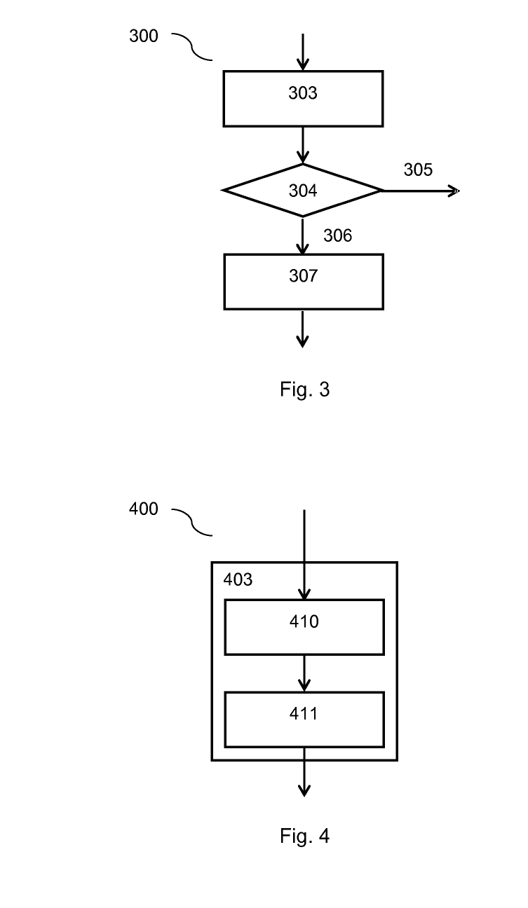

Further, with reference to FIG. 3, the method may comprise the steps of detecting 303 a card expiration date, e.g. in the form of four digits YYMM, in the first track data, the second track data and/or the third track data. If a card expiration date is detected 304, 306, the data may be truncated 307. The steps of 300 may be executed for the first and second track data, wherein any characters following the card expiration date may be truncated 307, e.g. by replacing them with wildcard characters, e.g. ‘X’.

With reference to FIG. 4, a method 400 of detecting 403 a valid primary account number is disclosed. The method generally comprises detecting 410 a primary account number and validating 411 any detected primary account number. Examples of the method 400 are disclosed in relation to the steps 203a, 203b and 203c described above wherein any detected valid primary account numbers are validated by identifying particular characters surrounding the detected primary account numbers. In addition to or as an alternative, any detected primary account numbers may be validated by a validation algorithm such as the Luhn algorithm. The Luhn algorithm is specified in ISO/IEC 7812-1 and is also described in U.S. Pat. No. 2,950,048. The Luhn algorithm comprises:

a. Doubling the value of alternate digits of the primary account number beginning with the second digit from the right (the rightmost digit is the check digit.).

b. Adding the individual digits comprising the products obtained in (a) to each of the unaffected digits in the original number.

c. The added total obtained in (c) must be a number ending in zero (30, 40, 50, etc.) for the account number to be validated.

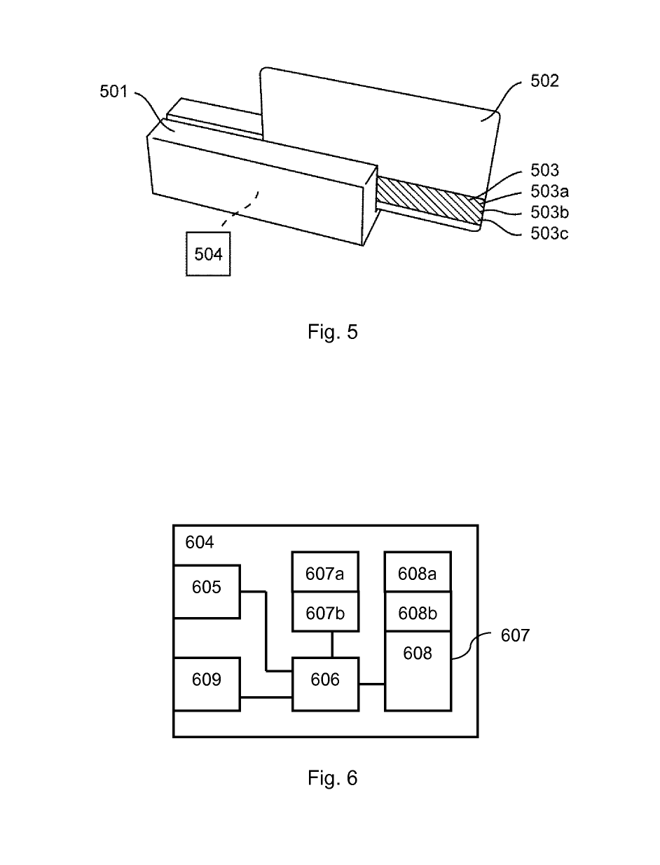

With reference to FIG. 5, a card reader 501 is disclosed together with a card 502 provided with a magnetic stripe 503. The magnetic stripe comprises a first data track 503a, a second data track 503b and a third data track 503c. The card reader further comprises an electronic arrangement 504 for reading and processing data from the card.

The method disclosed herein, or parts thereof, could be implemented in a card reader e.g. by one or more of: a processor or a micro processor and adequate software and memory for storing thereof, a Programmable Logic Device (PLD) or other electronic component(s) or processing circuitry configured to perform the actions described above.

In FIG. 6 a schematic example of an electronic arrangement 604 for reading and processing data from the card is shown. The electronic arrangement comprises an input means 605 configured to read data stored in a card. In the case of a magnetic stripe card this may comprise a magnetic head for reading one or more data tracks comprised by the magnetic stripe on the card. The electronic arrangement may further comprise an output means 609 for transmitting data from the card reader, e.g. in the form of a universal serial bus (USB) connection. The arrangement further comprises a processing unit 606. The processing unit 606 may be a single unit or a plurality of units to perform different actions of procedures described herein.

Furthermore, the card reader comprises at least one computer program product 607 in the form of a non-volatile memory, e.g. an EEPROM (Electrically Erasable Programmable Read-Only Memory) and/or a flash memory. The computer program product 607 comprises a computer program 608, which comprises code means, which when executed in the processing unit 606 in the card reader causes the arrangement to perform the actions e.g. of the procedure described earlier in conjunction with FIGS. 1 to 4.

The computer program 608 may be configured as a computer program code structured in computer program modules. Hence, in an exemplifying embodiment, the code means in the computer program 608 of the card reader may comprise a plurality of code means 608a, 608b etc, e.g. to process data of different tracks.

Although the code means in the embodiment disclosed above in conjunction with FIG. 6 are implemented as computer program modules which when executed in the processing unit causes the unit to perform the actions described above in the conjunction with figures mentioned above, at least one of the code means may in alternative embodiments be implemented at least partly as hardware circuits.

A previously mentioned, the processor may be a single CPU (Central processing unit), but could also comprise two or more processing units. For example, the processor may include general purpose microprocessors; instruction set processors and/or related chips sets and/or special purpose microprocessors such as ASICs (Application Specific

Integrated Circuits). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the card reader or connected devices. It is to be understood that the units or modules described in this disclosure are to be regarded as logical entities and not with necessity as separate physical entities.

It will be clear to one skilled in the art that the above embodiments may be altered in many ways without departing from the scope of the invention. Accordingly, the scope of the invention should be determined by the following claims and their legal equivalents. However, as is readily appreciated by a person skilled in the art, other embodiments than the ones disclosed above are equally possible within the scope of the invention, as defined by the appended patent claims.

1. A method performed by a card reader, comprising:
receiving in the card reader a card comprising data stored on the card, indicating the identity of a person;
obtaining data from the card;
detecting any valid primary account number in the data; and
upon detecting a valid primary account number in the data, truncating the data by redacting parts of the detected valid primary account number to remove sensitive data while maintaining the issuer identification number of the primary account number and the last four digits of the valid primary account number.

2. The method according to claim 1, followed by the step of transmitting the data to a system and using the data to indicate the identity of the person.

3. The method according to any claim 1, wherein the card is a magnetic stripe card.

4. The method according to claim 3, wherein the magnetic stripe comprises a plurality of tracks, preferably a first track, a second track and a third track, and wherein data is obtained from respective track as first track data, second track data and third track data.

5. The method according to claim 1, wherein the card is an integrated circuit card and wherein first track data, second track data and third track data are constructed from the data obtained from the card.

6. The method according to claim 4, wherein each of the first track data, the second track data and the third track data is truncated individually upon detection of a valid primary account number in the respective track data.

7. The method according to claim 6, wherein detecting any valid primary account number in the data comprises detecting characters in the track data before and or after a detected primary account number.

8. The method according to claim 4, wherein detecting any valid primary account number in the data from the first track comprises detecting an initial character ‘B’ initiating the track, detecting a primary account number following the initial character and detecting a following character ‘̂’ following the primary account number, in the data from the first track.

9. The method according to claim 4, wherein detecting any valid primary account number in the data from the second track comprises detecting a primary account number, detecting a following character ‘=’ following the primary account number, detecting a sequence following the following character comprising any two digits, followed by a digit ‘0’ or ‘1’, followed by any digit, followed by a digit ‘1’, ‘2’, ‘5’, ‘6’, ‘7’ or ‘9’, followed by a digit ‘0’, ‘2’, or ‘4’, followed by a digit ‘0’, ‘1’, ‘2’, ‘3’, ‘4’, ‘5’, ‘6’ or ‘7’, in the data from the second track.

10. The method according to claim 8, further comprising detecting a card expiration date in the data comprising the detected valid primary account number and truncating the data by redacting parts of the data, preferably parts or all data following the card expiration date.

11. The method according to claim 4, wherein detecting any valid primary account number in the data from the third track comprises detecting two initial digits initiating the track, followed by a primary account number, in the data from the third track.

12. The method according to claim 1, wherein detecting any valid primary account number in the data comprises detecting a primary account number in the data and validating the primary account number using the Luhn algorithm.

13. The method according to claim 1, wherein detecting any primary account number in the data comprises finding a contiguous sequence of 13 to 20 digits, wherein the first digit of the sequence is one of 3, 4, 5 and 6.

14. The method according to claim 1 wherein parts of the detected primary account number are redacted by replacing the digits in the parts of the detected valid primary account number by other characters, preferably wildcard characters.

15. The method according to claim 1 wherein the data comprises loyalty data, such as frequent flyer number data, which is unaffected by any truncation of the data.

16. A card reader comprising:
an input means configured to read data stored in a card; and
a processing unit adapted to receive the data, and detect any valid primary account number in the data, wherein the processing unit is adapted to, upon detecting a valid primary account number in the data, truncating the data by redacting parts of the detected valid primary account number while maintaining the issuer identification number of the valid primary account number and the last four digits of the valid primary account number.

17. The card reader according to claim 16 wherein the card reader is a magnetic card reader for reading magnetic stripe cards.

18. The card reader according to claim 16 wherein the card reader is an integrated circuit card reader for reading data from integrated circuit cards.

19. The card reader according to claim 16 wherein the processing unit is adapted to receive first track data, second track data and third track data from the card.

20. The card reader according to claim 19, comprising computer program, comprising computer readable code means, which when run in the card reader causes the card reader to perform the method according to claim 1.

21. A computer program, comprising computer readable code means, which when run in a card reader causes the card reader to perform the method according to claim 1.

22. A computer program product comprising computer program according to claim 21.
